(19) United States
(12) Patent Application Publication
(10) Pub. No.: US 2024/0226805 A1
(43) Pub. Date: Jul. 11, 2024

(54) HUMIDITY CONTROL MATERIAL AND HUMIDITY CONTROL MATERIAL WITH PACKAGING MATERIAL

(71) Applicant: SHARP KABUSHIKI KAISHA, Sakai City, Osaka (JP)

(72) Inventors: KYOKO MATSUURA, Sakai City, Osaka (JP); TSUYOSHI KAMADA, Sakai City, Osaka (JP); MASAKAZU KAMURA, Sakai City, Osaka (JP); SHO OCHI, Sakai City, Osaka (JP); TETSUYA IDE, Sakai City, Osaka (JP); HIROKA HAMADA, Sakai City, Osaka (JP); SATORU MOTONAMI, Sakai City, Osaka (JP); Yuusuke SHIMIZU, Sakai City, Osaka (JP)

(21) Appl. No.: 18/562,034

(22) PCT Filed: Mar. 30, 2022
(86) PCT No.: PCT/JP2022/015795

§ 371 Date: Nov. 17, 2023

(30) Foreign Application Priority Data
May 21, 2021 (JP) 2021-085885
Sep. 27, 2021 (JP) 2021-156223

(51) Int. Cl. B01D 53/28; B01J 20/12; B01J 20/26; B65D 81/26

(52) U.S. Cl. CPC B01D 53/28; B01J 20/12; B01J 20/261; B65D 81/266; B01D 2253/202; B01D 2257/80

(57) ABSTRACT

A humidity control material includes the following: a water absorber including a water absorbing material; and a humidity control ingredient contained in the water absorbing material, and configured to absorb or release moisture. The humidity control ingredient includes a metal salt having a deliquescence point falling within a relative humidity of 30 to 80% RH inclusive.

### TECHNICAL FIELD

The present disclosure relates to a humidity control material, and a humidity control material with a packaging material. The present application claims priority from Japanese Patent Application No. JP2021-085885, filed on May 21, 2021, and Japanese Patent Application No. JP2021-156223, filed on Sep. 27, 2021, the contents of which are hereby incorporated by reference into this application.

### BACKGROUND ART

Humidity control materials have a higher humidity control capability in a wide humidity range from a low to a high than widely used desiccants made of, but not limited to, B-type silica gel. Humidity control materials can be thus utilized in extensive use applications.

Patent Literature 1 discloses a hygroscopic composition containing at least one of sodium acetate and potassium acetate, as well as a water absorbing binder, wherein the ratio between the total amount of the sodium acetate and potassium acetate (Ac) and the amount of the water absorbing binder (B), Ac:B [mass ratio], ranges from 2:3 to 4:1. Accordingly, sodium acetate and/or potassium acetate, both of which are non-halogen inorganic salts, can be used, thereby offering a hygroscopic composition that is inexpensive and has high hygroscopicity, and that has a low possibility of metal rust or other things and is thus highly safe.

### CITATION LIST

### Patent Literature

### SUMMARY OF INVENTION

### Technical Problem

It is unfortunately difficult to use conventional humidity control materials in a use application where exerting a high humidity control capability in a particular humidity range is important.

One aspect of the present disclosure has been made in view of this problem. One aspect of the present disclosure aims to offer a humidity control material that can be used in, for instance, a use application where exerting a high humidity control capability in a particular humidity range is important, and to offer a humidity control material with a packaging material that can be used in the foregoing use application.

### Solution to Problem

A humidity control material according to one aspect of the present disclosure includes the following: a water absorber including a water absorbing material; and a humidity control ingredient contained in the water absorbing material, and configured to absorb or release moisture. The humidity control ingredient includes a metal salt having a deliquescence point falling within a relative humidity of 30 to 80% RH inclusive.

A humidity control material with a packaging material according to another aspect of the present disclosure includes the following: the humidity control material according to the one aspect of the present disclosure; and a packaging material having moisture permeability, and packaging the humidity control material.

### BRIEF DESCRIPTION OF DRAWINGS

FIG. 1 is a schematic sectional view of a humidity control material according to a first embodiment, and a humidity control material according to a second embodiment.

FIG. 2 is an image illustrating a change in the transparency of the humidity control material according to the first embodiment due to the relative humidity of the air around the humidity control material.

FIG. 3 is a graph showing the moisture sorption isotherms of sodium acetate, sodium propionate and sodium formate at a temperature of 25° C.

FIG. 4 is a graph showing the moisture sorption isotherm of a moisture absorbing ingredient including B-type silica gel, the moisture sorption isotherm of a humidity control ingredient including lithium chloride and glycerin, and the moisture sorption isotherm of a humidity control ingredient including sodium formate as a base component.

FIG. 5 is a graph showing the moisture sorption isotherm of a humidity control ingredient including lithium chloride and glycerin, and the moisture sorption isotherm of a humidity control ingredient including sodium formate as a base component.

FIG. 6 is a graph showing the moisture sorption isotherm of a humidity control material containing a humidity control ingredient composed of sodium formate, and the moisture sorption isotherm of a humidity control material containing a humidity control ingredient composed of 1 part by weight of sodium formate and 1 part by weight of glycerin.

FIG. 7 is a graph showing the moisture sorption isotherm of a humidity control material containing a humidity control ingredient composed of sodium formate, and the moisture sorption isotherm of a humidity control material containing a humidity control ingredient composed of 2 parts by weight of sodium formate and 1 part by weight of glycerin.

FIG. 8 is a graph showing the moisture sorption isotherm of a humidity control material containing a humidity control ingredient composed of sodium formate, and the moisture sorption isotherm of a humidity control material containing a humidity control ingredient composed of 2 parts by weight of sodium formate and 1 part by weight of potassium formate.

FIG. 9A schematically illustrates a method for manufacturing the humidity control material according to the first embodiment.

FIG. 9B schematically illustrates the method for manufacturing the humidity control material according to the first embodiment.

FIG. 9C schematically illustrates the method for manufacturing the humidity control material according to the first embodiment.

FIG. 10A is a schematic sectional view of a transport container during the daytime that is transported from a hot and humid region to a cold region.

FIG. 10B is a schematic sectional view of the transport container during the nighttime that is transported from a hot and humid region to a cold region.

FIG. 11 is a schematic plan view of a first example of a water absorber included in the humidity control material according to the first embodiment.

FIG. 12 is a schematic perspective view of a second example of the water absorber included in the humidity control material according to the first embodiment.

FIG. 13 is a schematic sectional view of a third example of the water absorber included in the humidity control material according to the first embodiment.

FIG. 14 is a schematic sectional view of a fourth example of the water absorber included in the humidity control material according to the first embodiment.

FIG. 15 is a schematic sectional view of a fifth example of the water absorber included in the humidity control material according to the first embodiment.

FIG. 16 schematically illustrates example color changes that are displayed by the humidity control material according to the second embodiment.

FIG. 17 illustrates a humidity control material according to a third embodiment.

FIG. 18 is a schematic sectional view of a humidity control material with a packaging material according to a fourth embodiment.

### DESCRIPTION OF EMBODIMENTS

The embodiments of the present disclosure will be described with reference to the drawings. It is noted that with regard to the drawings, identical or equivalent components will be denoted by the same signs, and the description of redundancies will be omitted.

### 1 First Embodiment

### 1.1 Humidity Control Material

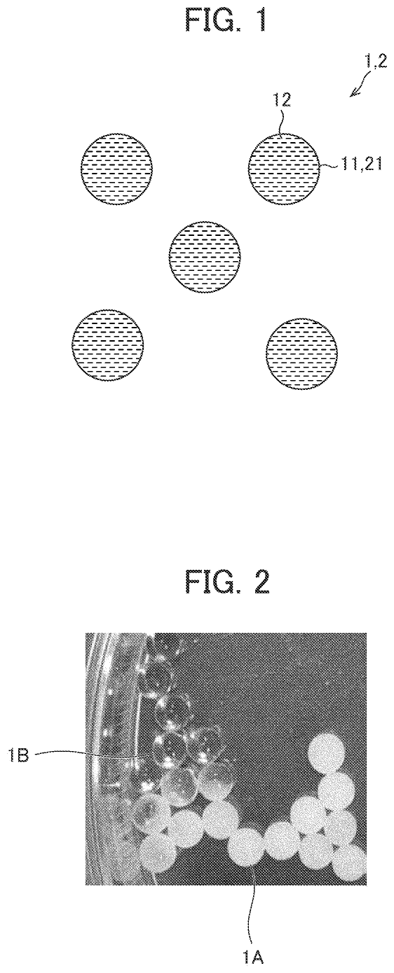

FIG. 1 is a schematic sectional view of a humidity control material according to a first embodiment.

A humidity control material 1 according to the first embodiment illustrated in FIG. 1 has a humidity control capability to absorb moisture from the air around the humidity control material 1 when the relative humidity of the air around the humidity control material 1 is higher than the equilibrium humidity of the humidity control material 1, and to release moisture to the air around the humidity control material 1 when the relative humidity of the air around the humidity control material 1 is lower than the equilibrium humidity of the humidity control material 1. The humidity control material 1 can desorb moisture through heating at a relatively lower temperature than a desiccant as typified by A-type silica gel. The humidity control material 1 can also absorb and release moisture repeatedly. The humidity control material 1 can thus in principle maintain its humidity control capability almost permanently. The equilibrium humidity of the humidity control material 1 can be regulated by materials constituting the humidity control material 1.

As illustrated in FIG. 1, the humidity control material 1 includes water absorbers 11 and humidity control ingredients 12. Each water absorber 11 is composed of a water absorbing material 21. Each humidity control ingredient 12 is contained in the water absorbing material 21. The humidity control ingredient 12 absorbs or releases moisture. The humidity control ingredient 12 includes a component that deliquesces.

The water absorber 11 and the water absorbing material 21 have a particulate shape. The water absorber 11 and the water absorbing material 21 have a diameter of, for instance, several millimeters to several tens of millimeters.

The water absorbing material 21 can chemically or physically absorb the component that deliquesces, and that is included in the humidity control ingredient 12. This can prevent syneresis of the deliquesced component from the water absorbing material 21 due to its separation from the water absorbing material 21. When the humidity control ingredient is a humidity control liquid, the water absorbing material 21 can be impregnated with the humidity control liquid. The water absorbing material 21 of 100 parts by weight is desirably impregnated with a humidity control liquid of 1 to 1000 parts by weight inclusive. Using a humidity control liquid impregnated in the water absorbing material 21 can increase the area of the interface between the humidity control ingredient and the air when compared to an instance where the humidity control liquid is used alone. This can accelerate the speed of humidity control.

The water absorbing material 21 includes at least one selected from the group consisting of a water absorbing resin and a clay mineral.

The water absorbing resin may be an ionic resin or a non-ionic resin.

The ionic resin includes at least one selected from the group consisting of, for instance, a polyacrylic alkali metal salt and a starch-acrylate graft polymer. The polyacrylic alkali metal salt includes sodium polyacrylate for instance.

The non-ionic resin includes at least one selected from the group consisting of, for instance, a vinyl acetate copolymer, a maleic anhydride copolymer, polyvinyl alcohol, and polyalkylene oxide.

The clay mineral includes at least one selected from the group consisting of, for instance, a silicate mineral and a zeolite. The silicate mineral includes at least one selected from the group consisting of, for instance, sepiolite, attapulgite, kaolinite pearlite, and dolomite.

The humidity control ingredient 12 includes a metal salt having a deliquescence point falling within a relative humidity of 30 to 80% RH inclusive. The metal salt desirably forms hydrate crystals within the relative humidity of 30 to 80% RH inclusive. Accordingly, the humidity control ingredient 12 has a threshold humidity within the relative humidity of 30 to 80% RH inclusive; the humidity control ingredient 12 can little absorb moisture when the relative humidity of the surrounding air is lower than the threshold humidity, and the humidity control ingredient 12 can absorb moisture when the relative humidity of the surrounding air is higher than the threshold humidity. The metal salt includes a carboxylate for instance. The carboxylate includes at least one selected from the group consisting of, for instance, sodium formate, sodium acetate, and sodium propionate.

The humidity control ingredient 12 may include another component different from the foregoing metal salts. For instance, the humidity control ingredient 12 may include an additive for regulating the foregoing threshold humidity. The additive includes at least one selected from the group consisting of, for instance, another metal salt different from the foregoing metal salts, a polyhydric alcohol, and a nucleation material of a hydrate crystal of the foregoing metal salt.

The other metal salt includes at least one of, for instance, lithium chloride, calcium chloride, magnesium chloride, sodium benzoate, lithium bromide, calcium bromide, potassium bromide, sodium lactate, potassium lactate, potassium acetate, lithium acetate, potassium formate, sodium butyrate, sodium citrate, potassium citrate, sodium chloride, and potassium carbonate.

The polyhydric alcohol includes at least one selected from the group consisting of, for instance, glycerin, propanediol, butanediol, pentanediol, trimethylolpropane, butanetriol, ethylene glycol, diethylene glycol, triethylene glycol, and lactic acid, and the polyhydric alcohol desirably includes a polyhydric alcohol having three or more hydroxyls. The polyhydric alcohol having three or more hydroxyls includes glycerin for instance. The polyhydric alcohol may constitute a dimer or a polymer.

The nucleation material includes at least one selected from the group consisting of a carboxylic acid having two or more carboxyl groups, and an amide having two or more amide groups.

The metal salt having a deliquescence point within the relative humidity of 30 to 80% RH inclusive has a threshold humidity constituting a boundary between a relative humidity at which moisture absorption cannot be performed substantially, and a relative humidity at which moisture absorption can be performed substantially. The relative humidity at which moisture absorption cannot be performed substantially is a relative humidity at which the metal salt forms, together with water molecules, firm hydrate crystals, and/or a relative humidity lower than a threshold humidity including a deliquescence point for deliquescence and liquefaction. The relative humidity at which moisture absorption can be performed substantially is a relative humidity higher than this threshold humidity. Further, the humidity control ingredient 12 has a threshold humidity constituting a boundary between a relative humidity at which moisture absorption cannot be performed substantially due to its metal salt, and a relative humidity at which moisture absorption can be performed substantially. The additive is a substance having hygroscopicity and high water solubility, and the additive changes the threshold humidity of the humidity control ingredient 12 from the threshold humidity of the metal salt. Thus, including an appropriate additive in the humidity control ingredient 12 can offer the humidity control material 1 having a threshold humidity suitable for a use application.

The content of the additive within the humidity control ingredient 12 is desirably 10 to 90 wt % inclusive. For an additive content smaller than 10 wt %, changing the threshold humidity of the humidity control ingredient 12 from the threshold humidity of the metal salt tends to be difficult. For an additive content greater than the 90 wt %, the threshold humidity constituting the boundary between the relative humidity at which moisture absorption cannot be performed substantially and the relative humidity at which moisture absorption can be performed substantially tends to be unclear.

FIG. 2 is an image illustrating a change in the transparency of the humidity control material according to the first embodiment due to the relative humidity of the air around the humidity control material.

As illustrated in FIG. 2, for the water absorber 11 that is transparent, the humidity control material 1 constitutes a humidity control material 1A that is not transparent and is thus whitish, when the relative humidity of the air around the humidity control material 1 is lower than the threshold humidity of the humidity control ingredient 12, and when the humidity control ingredient 12 is thus crystallized, and the humidity control material 1 constitutes a humidity control material 1B that is transparent, when the relative humidity of the air around the humidity control material 1 is higher than the threshold humidity of the humidity control ingredient 12, and when the humidity control ingredient 12 is thus not crystallized. The humidity control material 1 thus can be used as a humidity indicator that indicates the relative humidity of the air around the humidity control material 1. Further, the threshold humidity of the humidity control ingredient 12 constitutes a boundary between the relative humidity of the humidity control material 1 that is transparent, and the relative humidity of the humidity control material 1 that is not transparent. The additive can adjust the boundary between the relative humidity of the humidity control material 1 that is transparent, and the relative humidity of the humidity control material 1 that is not transparent. The additive thus can regulate the relative humidity that is indicated by the humidity control material 1.

### 1.2 Threshold Humidity of Carboxylate

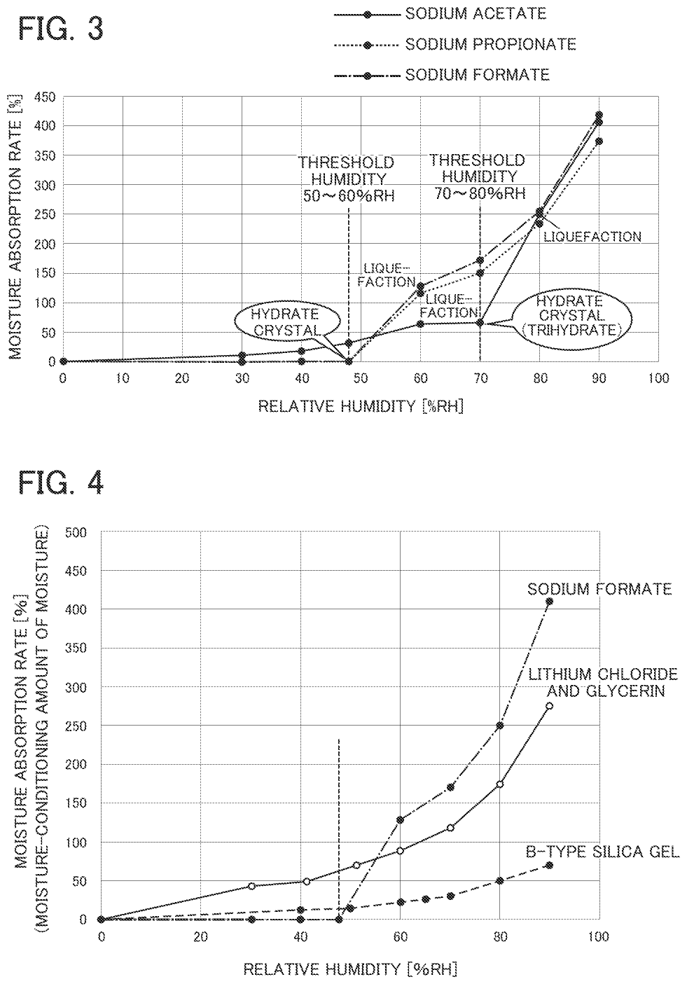

FIG. 3 is a graph showing the moisture sorption isotherms of sodium acetate, sodium propionate and sodium formate. The lateral axis of the graph shown in FIG. 3 indicates relative humidity, and the longitudinal axis of the same indicates moisture absorption rate.

A carboxylate, in particular, a carboxylic-acid sodium salt hydrates and forms, together with water molecules, firm hydrate crystals. The formed firm hydrate crystals further hydrate, deliquesce and liquefy. However, large energy is necessary for the formed firm hydrate crystals to further hydrate. Hence, upon the relative humidity reaching a first relative humidity, a carboxylate hydrates and forms, together with water molecules, firm hydrate crystals, and upon the relative humidity reaching a second relative humidity higher than the first relative humidity, these hydrate crystals deliquesce and liquefy. For instance, as shown in FIG. 3, sodium acetate forms, together with water molecules, firm hydrate crystals at a relative humidity of about 70% RH or smaller, and these hydrate crystals deliquesce and liquefy upon the relative humidity reaching about 80% RH. The hydrate crystals are trihydrates. Further, sodium propionate and sodium formate form, together with water molecules, firm hydrate crystals at a relative humidity of about 50% RH or smaller, and these hydrate crystals deliquesce and liquefy upon the relative humidity reaching about 60% RH.

As such, a carboxylate, in particular, a carboxylic-acid sodium salt has a threshold humidity including such a relative humidity as to form, together with water molecules, firm hydrate crystals, and/or including such a deliquescence point that the hydrate crystals deliquesce and liquefy. Thus, for a carboxylate, in particular, a carboxylic-acid sodium salt, further moisture absorption than that for forming hydrate crystals together with water molecules does not advance when the relative humidity of the surrounding air is lower than its threshold humidity, and moisture absorption advances abruptly to thus raise its moisture absorption rate when the relative humidity of the surrounding air becomes higher than the threshold humidity. For instance, as shown in FIG. 3, for sodium acetate, further moisture absorption than that for forming trihydrates does not advance when the relative humidity of the surrounding air is lower than about 70 to 80% RH, and moisture absorption advances abruptly to thus raise its moisture absorption rate when the relative humidity of the surrounding air becomes higher than about 70 to 80 % RH. Further, for sodium propionate and sodium formate, further moisture absorption than that for forming hydrate crystals does not advance when the relative humidity of the surrounding air is lower than about 50 to 60% RH, and moisture absorption advances abruptly to thus raise their moisture absorption rates when the relative humidity of the surrounding air becomes higher than about 50 to 60% RH.

As such, a carboxylate has a threshold humidity constituting a boundary between a relative humidity at which moisture absorption advances little, and a relative humidity at which moisture absorption advances abruptly. For instance, as shown in FIG. 3, sodium acetate has a threshold humidity of about 70 to 80% RH. Further, sodium propionate and sodium formate have a threshold humidity of about 50 to 60% RH.

FIG. 4 is a graph showing the moisture sorption isotherm of a moisture absorbing ingredient including B-type silica gel, the moisture sorption isotherm of a humidity control ingredient including lithium chloride and glycerin, and the moisture sorption isotherm of a humidity control ingredient including sodium formate as a base component. The lateral axis of the graph shown in FIG. 4 indicates relative humidity, and the longitudinal axis of the same indicates moisture absorption rate.

The moisture absorption rate of a moisture absorbing ingredient having no threshold humidity, and the moisture absorption rate of a humidity control ingredient having no threshold humidity increase slowly along with rise in relative humidity. For instance, as shown in FIG. 4, the moisture absorption rate of the moisture absorbing ingredient including B-type silica gel, and the moisture absorption rate of the humidity control ingredient including lithium chloride and glycerin increase slowly along with rise in their relative humidities. In contrast to this, the moisture absorption rate of the humidity control ingredient 12 having a threshold humidity is low within a relative humidity lower than its threshold humidity, and within a relative humidity higher than the threshold humidity, the moisture absorption rate of the same increases abruptly along with rise in its relative humidity. For instance, as shown in FIG. 4, the moisture absorption rate of the humidity control ingredient 12 including sodium formate as its base component is low to the extent that moisture absorption advances little, within a relative humidity of about 0 to 50% RH, and within a relative humidity of about 50 to 90% RH, the moisture absorption rate of the same increases abruptly along with rise in its relative humidity. Thus, the humidity control ingredient 12 having a threshold humidity has a threshold humidity separating a relative humidity at which moisture absorption advances little from a relative humidity at which moisture absorption advances abruptly. For instance, as shown in FIG. 4, the humidity control material including sodium formate as its base component has an about—50 to 60% RH threshold humidity separating a relative humidity at which moisture absorption advances little from a relative humidity at which moisture absorption advances abruptly.

Two or more kinds of carboxylates may be combined together and included in the humidity control ingredient 12. The foregoing additive may be included in the humidity control ingredient 12 to thus affect hydrate crystal formation, thereby regulating the threshold humidity and humidity control properties.

The foregoing threshold humidity enables the humidity control material 1 to be used in a use application where exerting a high humidity control capability in a particular humidity range is important. Further, the humidity control material 1 can be dried and renewed by low-temperature air having a relative humidity lower than the threshold humidity. That is, the humidity control material 1 does not require hot-air heating when it undergoes drying for renewal. For instance, when the humidity control ingredient 12 includes sodium formate as its base component, the humidity control material 1 can be dried and renewed by low-temperature air having a relative humidity lower than about 50 to 60% RH.

### 1.3 Humidity Control Effect Around Threshold Humidity

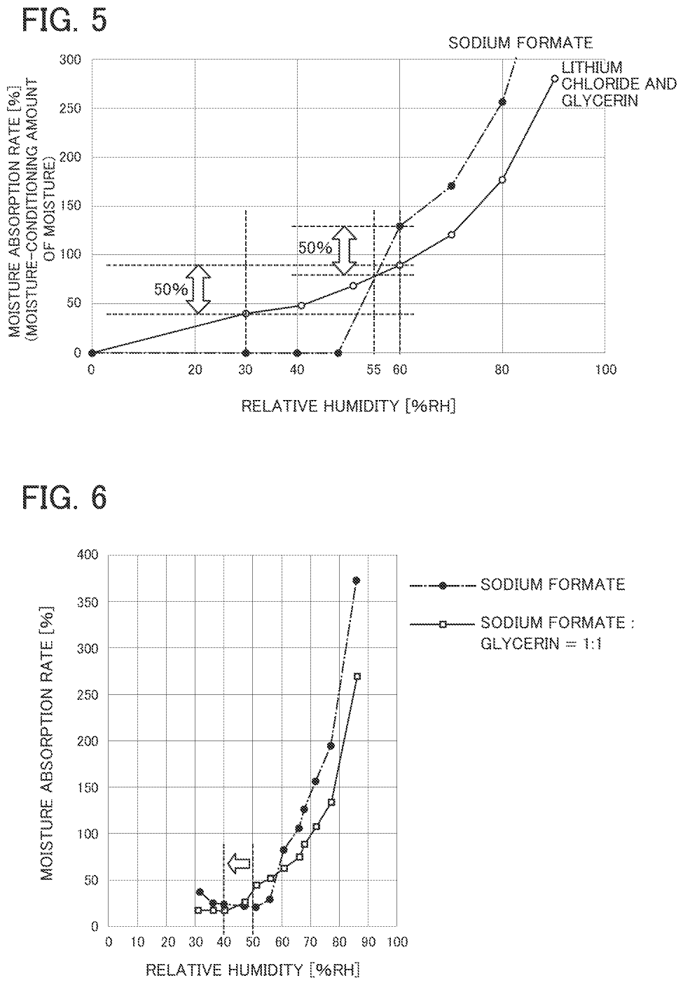

FIG. 5 is a graph showing the moisture sorption isotherm of a humidity control ingredient including lithium chloride and glycerin, and the moisture sorption isotherm of a humidity control ingredient including sodium formate as a base component. The lateral axis of the graph shown in FIG. 5 indicates relative humidity, and the longitudinal axis of the same indicates moisture absorption rate.

As described above, the moisture absorption rate of a humidity control ingredient having no threshold humidity increases slowly along with rise in relative humidity. Thus, equilibrium humidity changes greatly as a result of change in the moisture absorption rate of the humidity control ingredient, that is, change in the humidity control amount of moisture from the humidity control ingredient. For instance, as shown in FIG. 5, for a humidity control target humidity of 60% RH, the regulation humidity shifts from 60% RH to 30% RH when the humidity control ingredient including lithium chloride and glycerin releases moisture by 50% of the weight of a humidity control material excluding moisture. In contrast to this, the moisture absorption rate of the humidity control ingredient 12 having a threshold humidity is low within a relative humidity lower than its threshold humidity, and within a relative humidity higher than the threshold humidity, the moisture absorption rate of the same increases abruptly along with rise in the relative humidity. As such, the equilibrium humidity changes slightly as a result of change in the moisture absorption rate of the humidity control ingredient 12, that is, change in the humidity control amount of moisture from the humidity control ingredient 12. For instance, as shown in FIG. 5, for a humidity control target humidity of 60% RH, the regulation humidity shifts only from 60% RH to 55% RH when the humidity control ingredient 12 including sodium formate as its base component releases moisture by 50% of the weight of a humidity control material excluding moisture.

As such, around a threshold humidity, the humidity control ingredient 12 having the threshold humidity has a high humidity control effect and has a large humidity control amount of moisture. Thus, regulating the threshold humidity of the humidity control ingredient 12 around a humidity control target humidity enables the humidity control material 1 to condition the humidity of the surrounding air so as to maintain, for a long time, the relative humidity of the surrounding air at a relative humidity close to the humidity control target humidity.

### 1.4 Regulation of Threshold Humidity Using Additive

FIG. 6 is a graph showing the moisture sorption isotherm of a humidity control material containing a humidity control ingredient composed of sodium formate, and the moisture sorption isotherm of a humidity control material containing a humidity control ingredient composed of 1 part by weight of sodium formate and 1 part by weight of glycerin. The lateral axis of the graph shown in FIG. 6 indicates relative humidity, and the longitudinal axis of the same indicates moisture absorption rate.

As shown in FIG. 6, the humidity control material 1 containing the humidity control ingredient 12 composed of sodium formate has a threshold humidity of about 50% RH. In contrast to this, the humidity control material containing the humidity control ingredient 12 composed of 1 part by weight of sodium formate and 1 part by weight of glycerin has a threshold humidity of about 40% RH. Thus, FIG. 6 reveals that glycerin constitutes an additive that makes the threshold humidities of the humidity control material 1 and humidity control ingredient 12 lower than the threshold humidity of sodium formate.

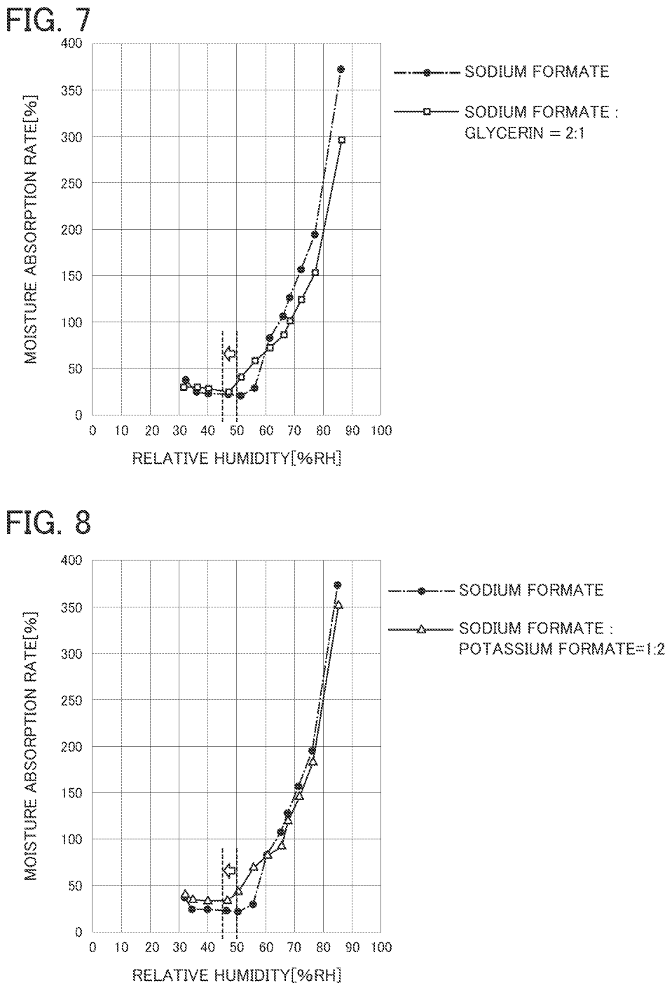

FIG. 7 is a graph showing the moisture sorption isotherm of a humidity control material containing a humidity control ingredient composed of sodium formate, and the moisture sorption isotherm of a humidity control material containing a humidity control ingredient composed of 2 parts by weight of sodium formate and 1 part by weight of glycerin. The lateral axis of the graph shown in FIG. 7 indicates relative humidity, and the longitudinal axis of the same indicates moisture absorption rate.

As shown in FIG. 7, the humidity control material 1 containing the humidity control ingredient 12 composed of sodium formate has a threshold humidity of about 50% RH. In contrast to this, the humidity control material containing the humidity control ingredient 12 composed of 2 parts by weight of sodium formate and 1 part by weight of glycerin has a threshold humidity of about 45% RH. As such, FIG. 7 reveals that glycerin constitutes an additive that makes the threshold humidities of the humidity control material 1 and humidity control ingredient 12 lower than the threshold humidity of sodium formate.

Further, a comparison between FIG. 6 and FIG. 7 reveals that the larger the content of glycerin that constitutes an additive is, the larger the amount of reduction in threshold humidity is.

FIG. 8 is a graph showing the moisture sorption isotherm of a humidity control material containing a humidity control ingredient composed of sodium formate, and the moisture sorption isotherm of a humidity control material containing a humidity control ingredient composed of 1 part by weight of sodium formate and 2 parts by weight of potassium formate. The lateral axis of the graph shown in FIG. 8 indicates relative humidity, and the longitudinal axis of the same indicates moisture absorption rate.

As shown in FIG. 8, the humidity control material 1 containing the humidity control ingredient 12 composed of sodium formate has a threshold humidity of about 50% RH. In contrast to this, the humidity control material containing the humidity control ingredient 12 composed of 1 part by weight of sodium formate and 2 parts by weight of potassium formate has a threshold humidity of about 45% RH. As such, FIG. 8 reveals that potassium formate constitutes an additive that makes the threshold humidities of the humidity control material 1 and humidity control ingredient 12 lower than the threshold humidity of sodium formate.

### 1.5 Method for Manufacturing Humidity Control Material

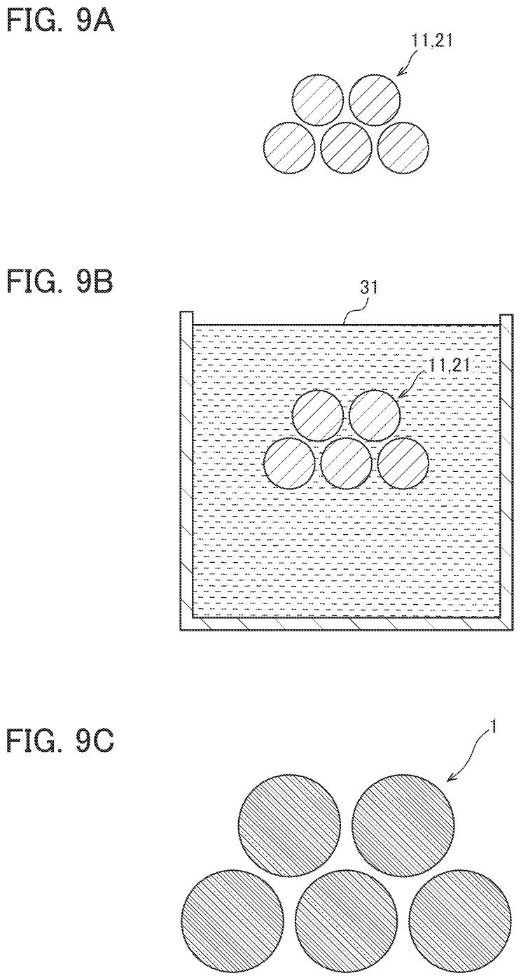

FIG. 9A, FIG. 9B, and FIG. 9C schematically illustrate a method for manufacturing the humidity control material according to the first embodiment.

In the manufacture of the humidity control material 1, the water absorber 11 is prepared, as illustrated in FIG. 9A.

The next is preparing a humidity control liquid 31, as illustrated in FIG. 9B. In addition, the prepared water absorber 11 is immersed into the prepared humidity control liquid 31. The water absorber 11 is immersed in the humidity control liquid 31 for, for instance, several hours to all day long. Accordingly, the humidity control liquid 31 permeates the water absorber 11, thus forming the humidity control material 1. The permeated humidity control liquid 31 constitutes the humidity control ingredient 12 that is to be included in the humidity control material 1.

The next is taking out the formed humidity control material 1 from the remaining humidity control liquid 31, as illustrated in FIG. 9C. The humidity control material 1 taken out is swelled, for instance, twice to twentyfold.

### 1.6 Dew-Condensation Prevention Effect

The humidity control material 1 has a high dew-condensation prevention effect. The humidity control material 1 is thus suitably used for preventing dew condensation that occurs, for instance, inside a transport container that is transported from a hot and humid region to a cold region. Such dew condensation tends to occur when goods, packing materials and others that are transported with a transport container contain a lot of moisture.

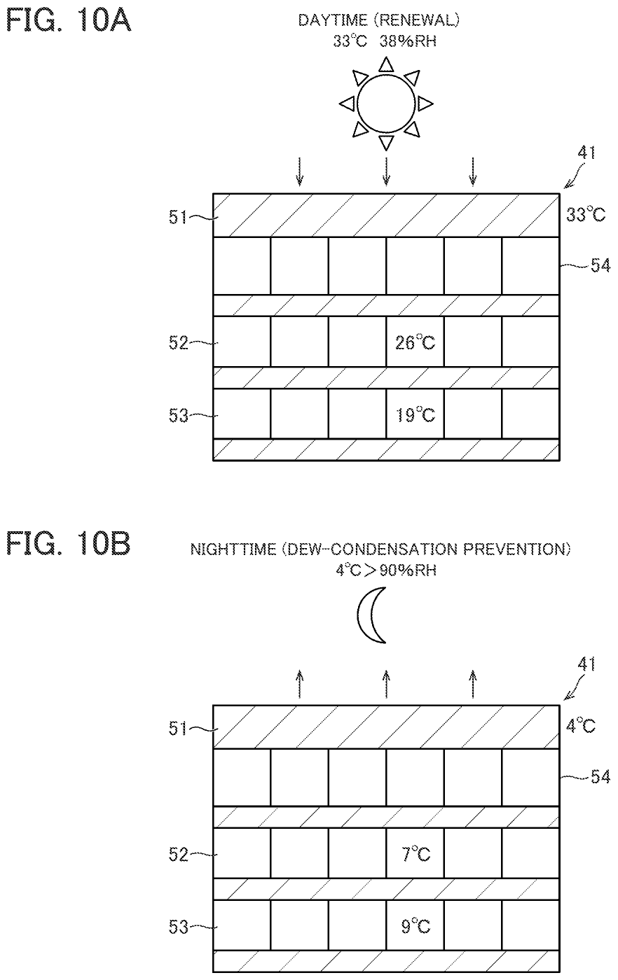

FIG. 10A is a schematic sectional view of a transport container during the daytime that is transported from a hot and humid region to a cold region. FIG. 10B is a schematic sectional view of the transport container during the nighttime.

Reference is made to an instance where, as illustrated in FIG. 10A, the temperature reaches 33° C. during the daytime, thus offering a relative humidity of 38% RH, and where, as illustrated in FIG. 10B, the temperature goes down to 4° C., thus offering a relative humidity greater than 90% RH.

When the temperature rises during the daytime like this, the inside temperature of a transport container 41 rises as well. For instance, as illustrated in FIG. 10A, the temperature of a ceiling surface 51 reaches 33° C., the temperature of middle air 52 reaches 26° C., and the temperature of lower air 53 reaches 19° C. Accordingly, moisture evaporates from the goods, packaging materials, wooden pallets and others accommodated in the transport container 41, and moisture evaporates from the floor or other parts of the transport container 41. Accordingly, the inside absolute humidity of the transport container 41 becomes high.

When the temperature becomes low during the nighttime as time goes by, the temperatures of the ceiling surface 51 and a wall surface 54, both constituting the transport container 41, become low due to the radiation from the ceiling surface 51 and wall surface 54. This reduces the amount of saturated water vapor of the air around the ceiling surface 51 and wall surface 54. Accordingly, the inside absolute humidity of the transport container 41 becomes higher than the amount of saturated water vapor of the air around the ceiling surface 51 and wall surface 54. This causes dew condensation on the ceiling surface 51 and wall surface 54.

It is noted that this temperature fluctuation inside the transport container 41 increases along with approach to the ceiling surface 51. For instance, the temperature difference in the ceiling surface 51 between the daytime and nighttime is 29° C., the temperature difference in the middle air 52 between the daytime and nighttime is 19° C., and the temperature difference in the lower air 53 between the daytime and nighttime is 10° C.

When the humidity control material 1 containing the humidity control ingredient 12 including sodium formate as its base component, and having the moisture sorption isotherm shown in FIG. 4 is disposed inside the transport container 41, the humidity control material 1 absorbs moisture to prevent dew condensation during the nighttime, at which the relative humidity is higher than the threshold humidity, and the humidity control material 1 releases moisture to be dried and renewed during the daytime, at which the relative humidity is lower than the threshold humidity. This can prevent dew condensation and can renew the humidity control material 1 without heating the humidity control material 1 with a heater. That is, the moisture absorption and renewal is cycled by a daily temperature cycle, and consequently, dew condensation can be prevented for a long time.

To efficiently cycle the moisture absorption and renewal by a daily temperature cycle, the threshold humidity of the humidity control ingredient 12 is regulated so as to be higher than a daytime relative humidity. This can achieve high dew-condensation prevention effect.

### 1.7 Prevention of Metal Corrosion

Table 1 shows relative values of the amount of metal corrosion with regard to chloride-free CMA, a chloride-free acetic acid compound, chloride-free sodium formate, chloride-containing sodium chloride, chloride-containing calcium chloride, chloride-containing magnesium chloride, and a chloride-containing acetic acid compound. CMA stands for calcium magnesium acetate. A chloride-containing acetic acid compound is a mixture of a chloride-free acetic acid compound and sodium chloride.

TABLE 1

| With or | | Amount of Metal |
|---|---|---|
| Without | | Corrosion |
| Chloride | Substance | (Relative Value) |
| Without | CMA | 0.004 |
| Chloride | (Calcium Magnesium Acetate) | |
| | Acetic Acid Compound | 0.003 |
| | Sodium Formate | 0.012 |
| With Chloride | Sodium Chloride | 1 |
| | Calcium Chloride | 1.5 |
| | Magnesium Chloride | 1.3 |
| | Acetic Acid Compound | 0.15 |
| | (Acetic Acid Compound and Sodium | |
| | Chloride) | |

Table 1 reveals that the amounts of metal corrosion of chloride-free CMA, a chloride-free acetic acid compound, and chloride-free sodium formate are significantly smaller than the amounts of metal corrosion of chloride-containing sodium chloride, chloride-containing calcium chloride, chloride-containing magnesium chloride, and a chloride-containing acetic acid compound.

Table 1 also reveals that the amount of metal corrosion of a chloride-containing acetic acid compound is smaller than the amounts of metal corrosion of chloride-containing sodium chloride, chloride-containing calcium chloride, and chloride-containing magnesium chloride.

As can be seen from the foregoing, the amount of metal corrosion of the humidity control ingredient 12 composed of a carboxylate, such as CMA, an acetic acid compound, or sodium formate, as its base component is smaller than the amount of metal corrosion of a humidity control ingredient composed of a chloride as its base component.

Thus, the humidity control material 1, which contains the humidity control ingredient 12 composed of a carboxylate as its base component, is less likely to cause metals or other things to rust and can be thus used in many use applications. For instance, the humidity control material 1 can be used in use applications, such as moisture-controlled storage of various metal-containing articles of taste, including musical instruments and cameras, and dew condensation prevention in the insides of electric boxes and transport containers.

### 1.8 Other Examples of Water Absorber

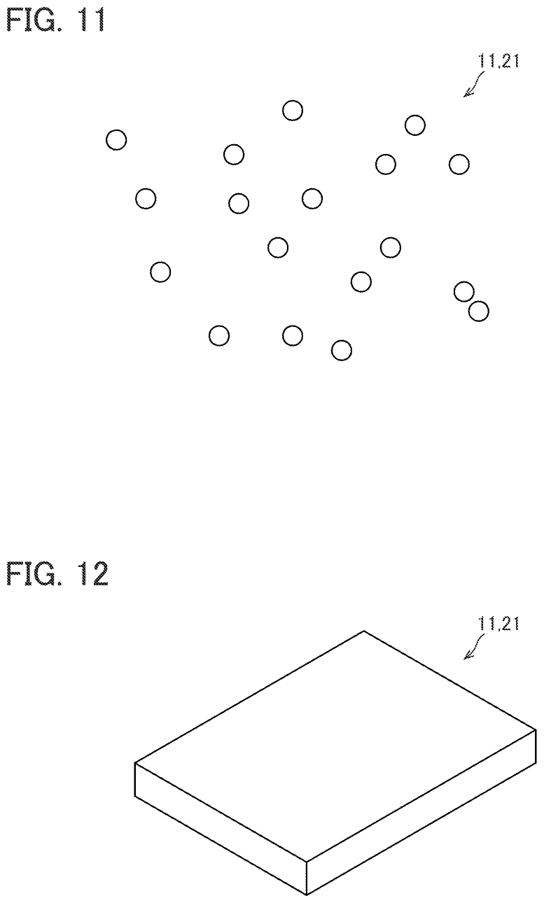

FIG. 11 is a schematic plan view of a first example of the water absorber included in the humidity control material according to the first embodiment.

The water absorber 11 illustrated in FIG. 11 is in the form of powders. The water absorber 11 illustrated in FIG. 11 has a diameter of, for instance, several micrometers to several millimeters.

FIG. 12 is a schematic perspective view of a second example of the water absorber included in the humidity control material according to the first embodiment.

The water absorber 11 illustrated in FIG. 12 is in the form of a sheet.

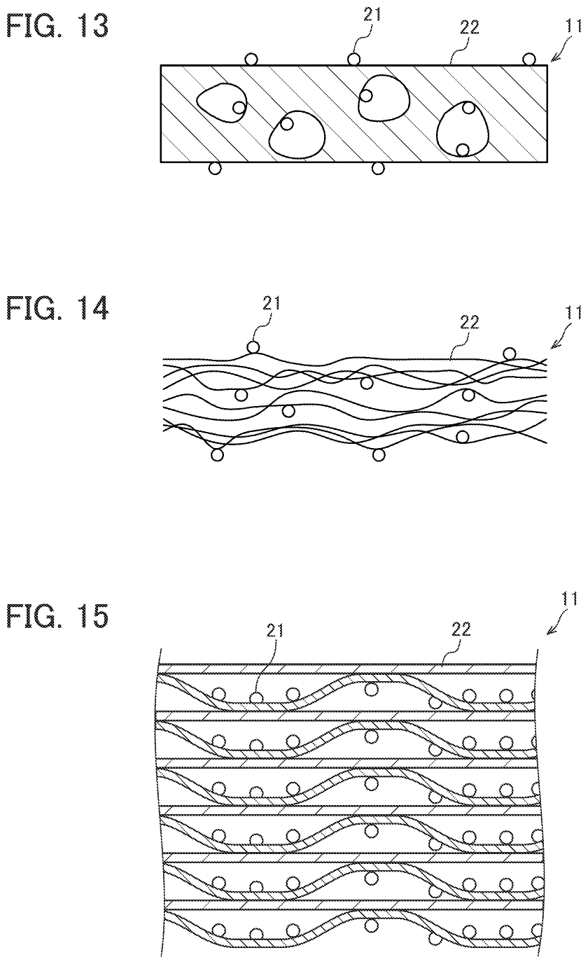

FIG. 13 is a schematic sectional view of a third example of the water absorber included in the humidity control material according to the first embodiment.

The water absorber 11 illustrated in FIG. 13 includes the water absorbing material 21 and a support 22. The water absorbing material 21 of the water absorber 11 illustrated in FIG. 13 is in the form of powders or particles. Further, the support 22 is a porous body. The porous body is a foamed body. Further, the water absorbing material 21 is supported by the support 22. When the porous body constituting the support 22 is a foamed body, the support 22 is highly rigid. This provides the humidity control material 1 having a stable shape. A humidity control liquid may be impregnated in the support 22.

FIG. 14 is a schematic sectional view of a fourth example of the water absorber included in the humidity control material according to the first embodiment.

The water absorber 11 illustrated in FIG. 14 includes the water absorbing material 21 and the support 22. The water absorbing material 21 of the water absorber 11 illustrated in FIG. 14 is in the form of powders or particles. Further, the support 22 is a porous body. The porous body is a non-woven textile or a woven textile. Further, the water absorbing material 21 is supported by the support 22. When the porous body constituting the support 22 is a non-woven textile or a woven textile, the support 22 is flexible. This enables the support 22 to undergo deformation. A humidity control liquid may be impregnated in the support 22.

FIG. 15 is a schematic sectional view of a fifth example of the water absorber included in the humidity control material according to the first embodiment.

The water absorber 11 illustrated in FIG. 15 includes the water absorbing material 21 and the support 22. The water absorbing material 21 of the water absorber 11 illustrated in FIG. 15 is in the form of powders or particles. Further, the support 22 is a ventilation member that allows an air flow to pass in a direction perpendicular to the cross section illustrated in FIG. 15. The ventilation member includes a corrugated non-woven textile for instance. Further, the water absorbing material 21 is supported by the support 22. With the water absorber 11 illustrated in FIG. 15, passing an air flow through the ventilation member can efficiently bring the water absorbing material 21 supported by the ventilation member into contact with the air, thus enabling the water absorbing material 21 to efficiently absorb moisture and to efficiently release moisture. The water absorber 11 illustrated in FIG. 15 may be incorporated in a rotator. A humidity control liquid may be impregnated in the support 22.

### 2 Second Embodiment

A difference between a second embodiment and the first embodiment will be described. With regard to what will not be described, a configuration similar to the configuration applied in the first embodiment is applied in the second embodiment.

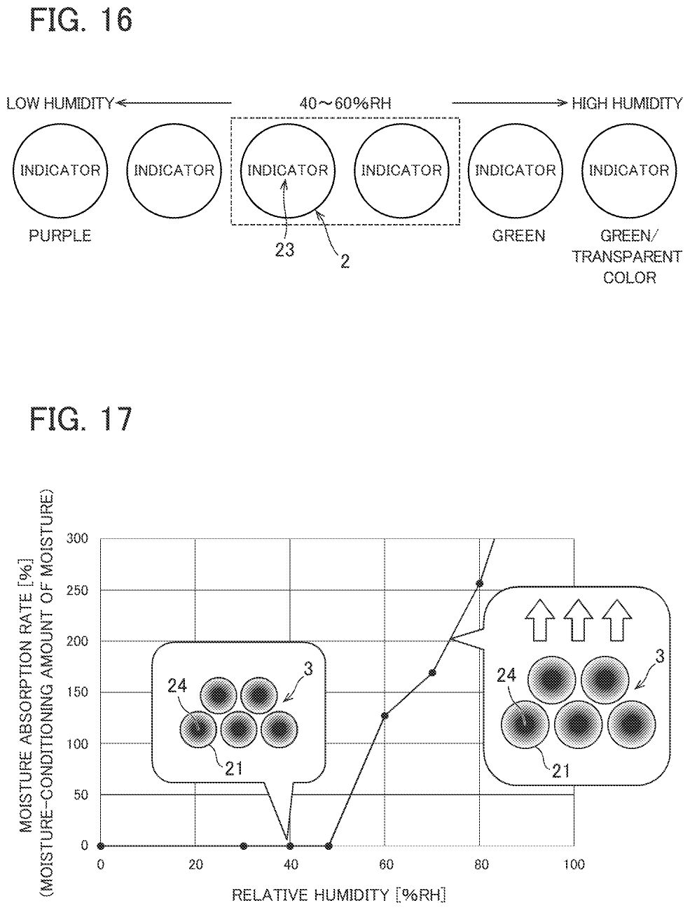

FIG. 1 is also a schematic sectional view of a humidity conditioning material according to the second embodiment. FIG. 16 schematically illustrates example color changes that are displayed by the humidity conditioning material according to the second embodiment.

As illustrated in FIG. 16, a humidity control material 2 according to the second embodiment includes an indicator 23. The indicator 23 displays color that changes in accordance with the moisture content of the humidity control ingredient 12. This can provide the humidity control material 2 with an indication function of displaying a moisture-controlled humidity by color.

The indicator 23 includes a pH indicator for instance. A pH indicator can be used as the indicator 23, because the pH of the humidity control ingredient 12 changes in accordance with the moisture content of the humidity control ingredient 12.

The pH indicator is at least one selected from the group consisting of, for instance, bromocresol green, methyl orange, methyl red, methyl purple, methylene blue, bromocresol purple, bromthymol blue, bromophenol blue, chlorophenol red, neutral red, phenol red, cresol red, curcumin, phenolphthalein, α-naphtholphthalein, thymolphtalein, and alizarine yellow.

The humidity control material 2 may contain two or more kinds of pH indicators. The two or more kinds of pH indicators are desirably pH indicators where displayed color changes in pH values different from each other. This can increase color change variations that are displayed by the humidity control material 2. Consequently, a moisture-controlled humidity can be checked more strictly.

FIG. 16 illustrates an instance where with the indicator 23, the humidity control material 2 displays purple when the relative humidity becomes lower than a range of 40 to 60% RH, and the humidity control material 2 displays green and then a transparent color when the relative humidity becomes higher than the range of 40 to 60% RH.

### 3 Third Embodiment

A difference between a third embodiment and the first embodiment will be described. With regard to what will not be described, a configuration similar to the configuration applied in the first embodiment is applied in the third embodiment.

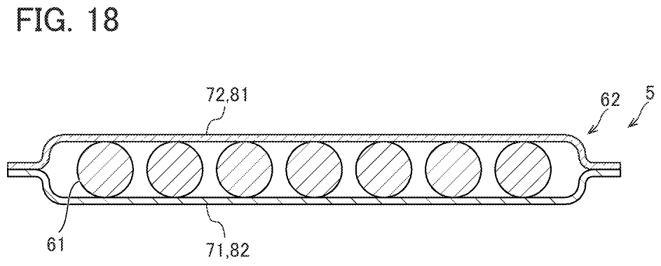

FIG. 17 illustrates a humidity control material according to the third embodiment.

A humidity control material 3 according to the third embodiment illustrated in FIG. 17 includes a scented material 24. The scented material 24 is contained in the water absorbing material 21.

When the relative humidity is lower than the threshold humidity, the carboxylate is crystalized, and the scented material 24 is incorporated in the crystals of the carboxylate. Thus, the scented material 24 is prevented from vaporizing from the humidity control material 3, and the scent is prevented from released from the humidity control material 3.

When the relative humidity is higher than the threshold humidity, the carboxylate's crystal structure is loosened, thus releasing the scented material 24 from the carboxylate. Thus, the scented material 24 vaporizes from the humidity control material 3, and the scent is released from the humidity control material 3.

This can provide the humidity control material 3 with the function of an aromatic agent whose aroma is triggered by a humidity change.

The scented material includes at least one selected from the group consisting of, for instance, acetylisoeugenol, acetyloeugenol, acetylcedrene, acetophenone, anise alcohol, anisaldehyde, anethole, allylamyl glycolate, allylionone, methyl anthranilate, benzyl benzoate, ionone, indole, eugenol, n-octanal, karon, camphor, benzyl cinnamate, geraniol, cedryl acetate, cinnamyl acetate, tricyclodecenyl acetate, phenylethyl acetate, o-t-butylcyclohexyl acetate, p-t-butylcyclohexyl acetate, benzyl acetate, amyl salicylate, cyclohexyl salicylate, sandalmysore core(2-methyl-4-(2,2,3-trimethyl-3-cyclopentene-1-yl)-2-butene-1-ol)), cis-3-hexenol, citral, citronellol, methyl dihydrojasmonate, dihydromyrcenol, terpineol, damaskone, thymol, decanal, δ-decalactone, γ-decalactone decyl aldehyde, terpineol, terpinene, n-nonanal, γ-nonalactone, methyl 2-nonenoate, bacdanol, pinene, phenylethyl alcohol, allyl phenoxyacetate, 1-(2-t-butylcyclohexyloxy)-2-butanol, flutate(ethyltricyclo[5.2.1.02,6]decane-2-ylcarboxylate), styrallyl propionate, benzyl propionate, n-hexanal, allyl hexanoate, α-hexyl cinnamic aldehyde, allyl heptanoate, heliotropin, benzyl alcohol, benzaldehyde, borneol, mylacaldehyde(4-(4-methyl-3-pentenyl)-3-cyclohexene-1-carboxaldehyde)), 4-methyl-3-decen-5-ol, ethyl 3-methyl-3-phenylglycidate, 3-methyl-5-phenylpentanol, ethyl 2-methylbutyrate, lime oxide, ethyl butyrate, ligustral(2,4-dimethyl-3-cyclohexenylcarboxaldehyde), linalool, limonene, styrax oil, tonka beans, pine oil, petitgrain oil, pepper oil, peppermint oil and rosemary oil.

### 4 Fourth Embodiment

FIG. 18 is a schematic sectional view of a humidity control material with a packaging material according to a fourth embodiment.

A humidity control material 5 with a packaging material illustrated in FIG. 18 includes a humidity control material 61 and a packaging material 62.

The humidity control material 61 is the foregoing humidity control material 1, 2, or 3.

The packaging material 62 has moisture permeability. The packaging material 62 packages the humidity control material 61.

Accordingly, the humidity control material 61 can be prevented from direct contact with a humidity control target object, and the humidity control material 61 can condition the moisture of the humidity control target object.

The packaging material 62 is a soft case being flexible and being in the form of a bag. The packaging material 62 may be a packaging material other than a soft case. An example of the packaging material other than a soft case is a box.

The packaging material 62 includes a moisture-permeable film 71 and a light-transparent film 72. The moisture-permeable film 71 has moisture permeability. An example of the moisture-permeable film 71 is a polyester non-woven textile. The light-transparent film 72 has light transparency. An example of the light-transparent film 72 is a polyethylene terephthalate film. The light-transparent film 72 allows the state of the humidity control material 61 to be visually observed. In particular, when the humidity control material 61 is the humidity control material 2 having an indication function, the color displayed in the indication function can be visually seen through the light-transparent film 72.

The packaging material 62 includes a front-surface material 81 and a back-surface material 82. In the fourth embodiment, the front-surface material 81 is the light-transparent film 72, and the back-surface material 82 is the moisture-permeable film 71. Only part of the front-surface material 81 may be the light-transparent film 72. The edge of the front-surface material 81 and the edge of the back-surface material 82 are welded together by a heat seal.

The present disclosure is not limited to the foregoing embodiments. The present disclosure may be replaced with a configuration that is substantially the same as the configurations described in the foregoing embodiments, with a configuration that substantially exerts the same action and effect as the foregoing configurations, or with a configuration that can substantially achieve the same object as the foregoing configurations.

1. A humidity control material comprising:
a water absorber including a water absorbing material; and
a humidity control ingredient contained in the water absorbing material, and configured to absorb or release moisture,
wherein the humidity control ingredient includes a metal salt having a deliquescence point falling within a relative humidity of 30 to 80% RH inclusive.

2. The humidity control material according to claim 1, wherein the metal salt forms a hydrate crystal within the relative humidity of 30 to 80% RH inclusive.

3. The humidity control material according to claim 1, wherein the metal salt includes a carboxylate.

4. The humidity control material according to claim 1, wherein the metal salt includes at least one selected from the group consisting of sodium formate, sodium acetate, and sodium propionate.

5. The humidity control material according to claim 1, wherein
the metal salt has a threshold humidity constituting a boundary between a relative humidity at which moisture absorption cannot be performed substantially, and a relative humidity at which moisture absorption can be performed substantially,
the humidity control ingredient has a threshold humidity constituting a boundary between a relative humidity at which moisture absorption cannot be performed substantially, and a relative humidity at which moisture absorption can be performed substantially, and
the humidity control ingredient includes an additive configured to change the threshold humidity of the humidity control ingredient from the threshold humidity of the metal salt.

6. The humidity control material according to claim 5, wherein the additive includes at least one selected from the group consisting of another metal salt different from the metal salt, a polyhydric alcohol, and a nucleation material of a hydrate crystal of the metal salt.

7. The humidity control material according to claim 6, wherein the another metal salt includes at least one of lithium chloride, calcium chloride, magnesium chloride, sodium benzoate, lithium bromide, calcium bromide, potassium bromide, sodium lactate, potassium lactate, potassium acetate, lithium acetate, potassium formate, sodium butyrate, sodium citrate, potassium citrate, sodium chloride, and potassium carbonate.

8. The humidity control material according to claim 6, wherein the polyhydric alcohol includes at least one selected from the group consisting of glycerin, propanediol, butanediol, pentanediol, trimethylolpropane, butanetriol, ethylene glycol, diethylene glycol, triethylene glycol, and lactic acid.

9. The humidity control material according to claim 6, wherein the nucleation material includes at least one selected from the group consisting of a carboxylic acid having two or more carboxyl groups, and an amide having two or more amide groups.

10. The humidity control material according to claim 5, wherein a content of the additive within the humidity control ingredient is 10 to 90 wt % inclusive.

11. The humidity control material according to claim 1, wherein the water absorber has a particulate shape, a powdery shape, or a sheet shape.

12. The humidity control material according to claim 1, wherein the water absorbing material includes at least one selected from the group consisting of a water absorbing resin and a clay mineral.

13. The humidity control material according to claim 12, wherein the water absorbing resin includes sodium polyacrylate.

14. The humidity control material according to claim 1, wherein the water absorber includes a support supporting the water absorbing material.

15. The humidity control material according to claim 14, wherein the support is a porous body.

16. The humidity control material according to claim 15, wherein the porous body is a foamed body, a non-woven textile, or a woven textile.

17. The humidity control material according to claim 1, comprising an indicator configured to display a color that changes in accordance with a moisture content of the humidity control ingredient.

18. The humidity control material according to claim 17, wherein the indicator includes a pH indicator.

19. The humidity control material according to claim 1, comprising a scented material contained in the water absorbing material.

20. A humidity control material with a packaging material, comprising:
the humidity control material according to claim 1; and
a packaging material having moisture permeability, and packaging the humidity control material.
